(19) United States
(12) Patent Application Publication
(10) Pub. No.: US 2009/0198603 A1
(43) Pub. Date: Aug. 6, 2009

(54) Flexible time-based disablement of equipment

(75) Inventors: Frank C. Simon, Hollywood, FL (US); Clayton R. Karmel, San Diego, CA (US); Earl Bugden, Mississauga (CA); Mike P. Simon, Hemet, CA (US)

Correspondence Address: CROWELL & MORING LLP;INTELLECTUAL PROPERTY GROUP, P.O. BOX 14300, WASHINGTON, DC, 20044-4300, US

(73) Assignee: Payment Protection Systems, Inc.

(21) Appl. No.: 12/068,028

(22) Filed: Jan. 31, 2008

(51) Int. Cl. G06Q 40/00; G06Q 99/00

(52) U.S. Cl. 705/35; 705/500

(57) ABSTRACT

Disclosed is a system and method for assuring the payment according to a repayment schedule of an obligation for using equipment by a device on the equipment. A subset of a plurality reference codes is selected. The current time and date and time are maintained. Reference codes in the subset are assigned to a specific time interval, wherein the specific time interval is a portion of a time period corresponding to repayment schedule of the obligation for using the equipment. The subset of the plurality of codes, the specific individual time interval to which each code is assigned, and the time period is stored. A user code is received via an interface. The received user code is compared to the subset of reference codes, the current time, current date, and time period corresponding to repayment schedule of the obligation. Based on the results of the comparison the equipment is disabled.

### FIELD

The following disclosure is generally concerned with electronic systems for disabling equipment in a flexible manner in response to failure by a user to make timely payments on a corresponding loan or other type of obligation.

### BACKGROUND

Systems exist that allow a lender to prevent the use of equipment, e.g., a vehicle or an appliance, such as a dishwasher or refrigerator, as well as other type of machinery or devices by disabling a critical component of the equipment. These devices included pre-programmed codes which were permanently assigned to a particular payment date. The codes in previous systems are assigned to a predetermined and fixed sequence of due dates with a minimal amount of “grace period” built in, if any. The codes are loaded into the device via a user computer interface, either by the lender, or the manufacturer, or the equipment seller. The user would then have to input the user codes in the exact order as stored in the device to continue using the equipment.

Any changes to the payment date requested by the purchaser (i.e., leasee, renter or similar type of person) would require a re-programming of the device and generation of a new code set. In addition, all code sets have to be maintained in a secure manner to prevent would-be hackers from obtaining the code set and defeating the equipment disablement device.

The reprogramming would also impact the lender and the vehicle seller if they were the authorized reprogrammer of the device because both would have to coordinate with the user to reprogram the device with new codes. The need to reprogram devices due to requests by the lender or purchaser consumes resources as well as time and requires a direct meeting between the purchaser and an authorized seller or other party that can reprogram the device.

There is a need for a payment assurance device and system that provides flexibility in the re-programming of time-based disablement of equipment.

### SUMMARY

Disclosed is an apparatus for assuring payment for use of equipment subject to an obligation. An exemplary apparatus includes a user interface for entering a numeric code by a user and display of status information. A memory stores reference codes associated with payments for use of the equipment and information related to payment due dates, wherein the reference codes are assigned to an unlimited number of future calendar dates. A processor maintains a clock and performs predetermined operations in response to a comparison of a numeric code entered via the user interface to the stored reference codes. A component controller transmits a signal to a component device based on the result of the comparison, the component device either enabling or disabling operation of a system required to operate the equipment based on the transmitted signal.

Disclosed is a method for assuring the payment according to a repayment schedule of an obligation for using equipment by a device on the equipment. The method includes selecting a subset of a plurality reference codes. The current time and date are maintained. Each of the reference codes in the subset is assigned to a specific time interval, wherein the specific time interval is a portion of a time period corresponding to repayment schedule of the obligation for using the equipment. The subset of the plurality of codes, the specific individual time interval to which each code is assigned, and the time period is stored. A user code is received via a user interface. The received user code is compared to the subset of reference codes, the current time, current date, and time period corresponding to repayment schedule of the obligation. Based on the results of the comparison the equipment is disabled.

### BRIEF DESCRIPTION OF THE DRAWING FIGURES

Exemplary embodiments will be described with reference to the following drawing figures:

FIG. 1 illustrates a flow chart of the steps to perform the exemplary embodiments; and

FIG. 2 illustrates a schematic diagram of an exemplary embodiment of the disclosed apparatus.

### DETAILED DESCRIPTION

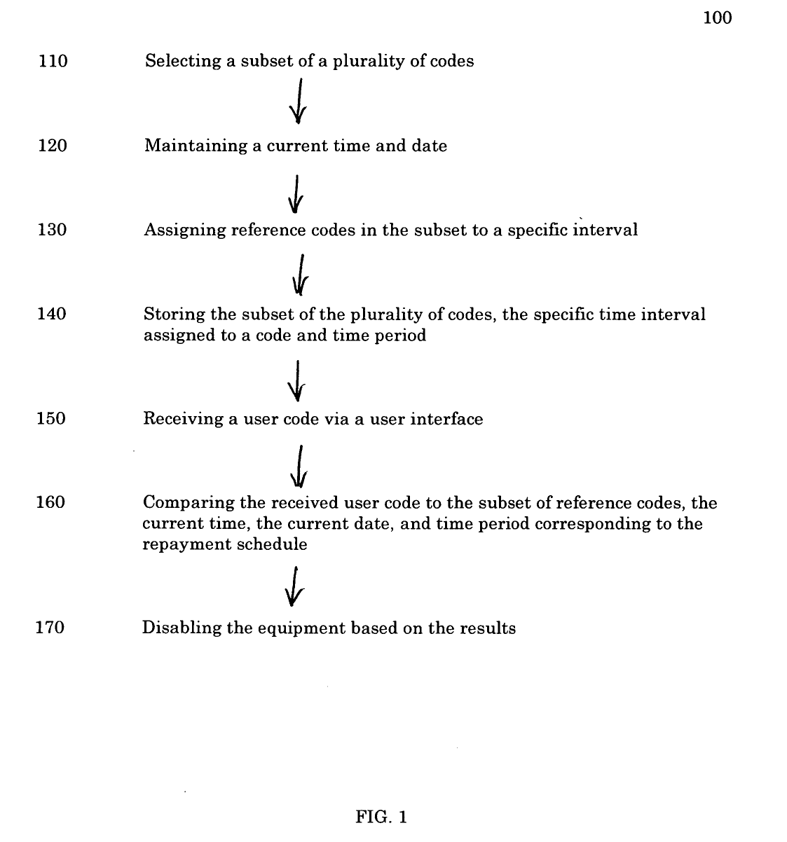

As illustrated in FIG. 1, a method 100 for assuring the payment according to a repayment schedule of an obligation for using equipment by device on the equipment is illustrated. The exemplary method comprises the step 110 of selecting a subset of a plurality of codes. A current time and date is also maintained by the device on the equipment (Step 120). In step 130, the reference codes in the subset are assigned to a specific time interval. The specific time interval can be a hour, day, month or some other period of time upon which a re-payment reschedule can be based. The specific time interval is a portion of a time period corresponding to the repayment schedule of the obligation for using the equipment. For example, if the repayment schedule is a monthly re-payment plan for five years (i.e. 60 months) then the specific time interval can be one month (e.g., payment due on the 10th calendar day of the month). Alternatively, if the equipment is a piece of machinery (e.g., backhoe) that is rented on an hourly basis, the specific time interval can be one hour, which is a portion of a time period, e.g., eight hours corresponding to the repayment schedule of the obligation for using the machinery.

Once the reference codes are assigned, a memory stores the subset of a plurality of codes, the specific individual time interval to which each code is assigned, and the time period (step 140). Of course, more or less information can be stored. For example, the stored information can include a base date of the repayment schedule, the date and time that the storing is performed, and a device identifier. The base date of the repayment schedule can be the first date of the specific time interval and the device identifier can be a serial number of the device that is on the equipment.

The device having a user interface receives a numeric code input by a user (step 150). The numeric code can be input via a numeric keypad or via a wireless connection, such as infrared or Bluetooth, or the like. The numeric code is provided to the purchaser user based on payments being made by the user in accordance with the re-payment schedule of the obligation. The user can receive the appropriate code from entities (financial institution, payment centers, equipment dealers and the like) or persons authorized to provide such information to the user. The user can then input the numeric code.

In step 160, the received numeric code is compared to the subset of reference codes, the current time, the current date, and the time period corresponding to the repayment schedule and the time interval.

Based on the results of the comparison, in step 170, the equipment is disabled. The equipment is disabled if the comparison is not favorable, in other words, if the numeric code input by the user does not match the reference code assigned to the specific interval then the equipment is disabled. Alternatively, if the comparison is favorable and the entered numeric code matches the reference code, the equipment is enabled for another time period according to the repayment schedule (e.g., 30 days) and can be continued to be used.

In selecting step 110, the selecting is performed by selecting the plurality of reference codes from a pre-existing set of reference code tables. The set of reference code tables has a greater number of codes than the selected subset of reference codes. The selected subset of reference codes excludes special codes and codes having repetitive sequence characters, for example, 444333.

The selecting step 110 further can include selecting a first special code for placing the device in an administrative mode. The administrative mode can be a dealer mode, a training mode, or a change mode. In dealer mode, the payment assurance device can be programmed with the details of the contractual obligation, such as repayment schedule start date, time period interval, payment assurance device identifier and so on. In change mode, settings such as reference and user numeric code length, number of grace days and the like can be changed. In training mode, the devices can be used by authorized users (e.g., dealers) to train employees on the operation of the payment assurance device.

The first special code can be shared by a plurality of devices having a device identifier similar to the device identifier of the device on the equipment. This would facilitate a device that is specifically made for a certain type of equipment, such as a backhoe, or similar device. In such a case, all of the payment assurance devices would have a device identifier that is similar to one another. The first special code is changeable or mutable so as to be only shared by a subgroup of the plurality of devices (e.g., backhoes rented in Idaho) based on the device identifier. A second special code is also selected in the selecting step 110. The second code is input by a user when the user desires to exit the administrative mode. In addition, if the device is left in the administrative mode for longer than a predetermined time period, the equipment is disabled. The maintenance of the current time and date in step 120 facilitates measuring the amount of time that the device is placed in the administrative mode.

The administrative mode allows a user, who can be an administrator or some other type of authorized person related to the repayment of the obligation, related to the installation or dealer of the device, or some other party. The administrative mode allows authorized persons to make changes to the device such as changing the payment due date, the repayment schedule which would correspond to the changing of the reference codes.

The device 140 also has a change code as a special code where the user inserts the change code via the user interface thereby placing the device in a change mode. In the change mode, a user enters change instruction codes corresponding to changes to the specification of new assignments and to new settings for the device. For example, code length, security code changes, number of grace days in the grace period, shutoff time, time zone and changes to dealer mode can be made in the change mode of the administrative mode. The change instruction code can also contain error detection encoding.

The storing step 140 includes a sub-feature of testing the functionality of the device to confirm proper operation. Afterwards, if the device functions properly, the stored information is uploaded to an Internet service, or some other proprietary network service. The Internet service is a secure service which is accessed by a user for releasing a specific user code assigned to a specific time interval stored in a specific device.

The reference codes can be generated by a random number generator that generates references codes comprised of only certain digits, characters or symbols. In the exemplary embodiment, the digits 1 to 4 are used, so the generated reference codes in a code table will be comprised of only the digits 1-4, but can have various lengths, such as 6 digits. Different random number generators can be used to create different sets of reference codes, which are stored in code tables. A code table is selected from a plurality of code tables based on a first criteria. The code table lists a plurality of codes. The code table can be one of 20 (or more or less) master code sequences tables (1 . . . 20) having a length 3000 (or more or less) individual codes. The first criteria can be the next code table in line (either in a forward or reverse direction) after completion of the initialization of a previous device, or a more sophisticated algorithm can be used, such as skipping to every third table (i.e., table 1, table 4, table 7, . . . and so on). However, the code can be anywhere from 1-16 digits in length, for example, 1234-4321-2341-3412. Of course, more or less digits, e.g., 1-7 or 1-3, can be used.

A subset of the 3000 or more or less codes is selected from the plurality of codes listed in a code table based on a second criteria. The subset can comprise between 400 and 1200 distinct codes. Any duplicate or repetitive codes are excluded. Examples of repetitive codes that are excluded include 4444, 3333, and in more complex cases, 1234 and if the next code in the sequence is 1235, either both are excluded or just one. A particular device's subset of codes is characterized by specifying the code sequence table (1 . . . 20) and an offset within that code sequence table. For example, say the subset comprises 605 codes, the offset can be chosen as the last code in the table, such as 3000 codes. The rest of the 605 codes will wrap around to the first code in the sequence table and extend to 604th code in the sequence. The total number of codes being 605 discrete codes.

The selected subset of codes and an additional codes are stored in a memory of a device. A user enters via a user interface to the device a code stored in the memory to initialize the device. The first criteria are a payment due date value and the second criteria is a code table offset value.

Unlike other systems that store a sequence of codes that are assigned to a pre-determined and fixed sequence of due dates, embodiments of the disclosed device store between 585-655 codes which correspond to 560-630 time intervals, such as days or hours, and 10-25 ‘special’ codes following a programmed ‘Start Day’. On any given day, the device can recognize any code within a 31 day, or any arbitrary number of days, window from the current paid-up day (or from the present day if the unit is in a grace period or lockout and backwards to the start of the grace period—that is, past the paid-up date), plus special pre-defined codes. When accepted, that day becomes the new paid-up day. The grace period days can begin from the paid-up date. Contract amounts, multiple payment streams, Greenwich Mean Time (GMT) offset, programmable options, the start day and code sequence are stored locally in the Dealer's PC, in the proprietary or Internet service network for Web-based dealers. However, start day, code sequence GMT offset and programmable options are preferably also stored in the network for each device. Personally identifiable information can be stored for Web-based dealers, when contracts are transferred between parties, or if a network backup option is elected.

For example, if a payment assurance device is in a grace period, it will accept ‘backwards’ payment dates, that will have the effect of advancing the pending ‘shut off’ date. A contract or obligation with a payment scheduled for payment due, for example, on the 10th day of a month with a 10-day grace period, could be extended by two days by entering the payment code for the 12th day of the month. That is, during the grace period, the ‘window’ for entering a payment code that is proper is forwarded 31 days and backwards to the start date (i.e., last paid-up date) of the grace period plus two days of margin for errors.

The 560-630 calendar day window ‘wraps’ over the reference codes indefinitely and any given code can be re-used a number of times. The codes and start date are preferably programmed at the factory or other location suitable for programming, and can not be changed except by the Factory or some entity that is authorized to program the device. The authorization can be from the factory, payment center, or a lending institution, for example. That is, device software locks out re-programming of the units.

To facilitate ‘on-lot’ operations, payment assurance devices are delivered in ‘factory/dealer’ mode and can be returned to this mode by the software installed on the device. In this mode, a single code allows starting or ‘locking’ of all cars. That is, enter the Dealer Code once to unlock, and once to lock. Or configure the device for Auto-Locking, where the car automatically invokes lockout mode 10 minutes before the anticipated turn off or 10 minutes after the car ignition is turned off. The Dealer Code is set to a value that is preferably common for all units, but can be modified by a PC connection using the device software. For example, entering a training code, such as 123456-78-9, disables the Factory/Dealer mode and enters customer mode. Dealer mode is indicated, for example, by a solid red light, but no beeping, or a solid green light when starting is enabled, but NO light when the equipment, in this example, a vehicle, ignition is on.

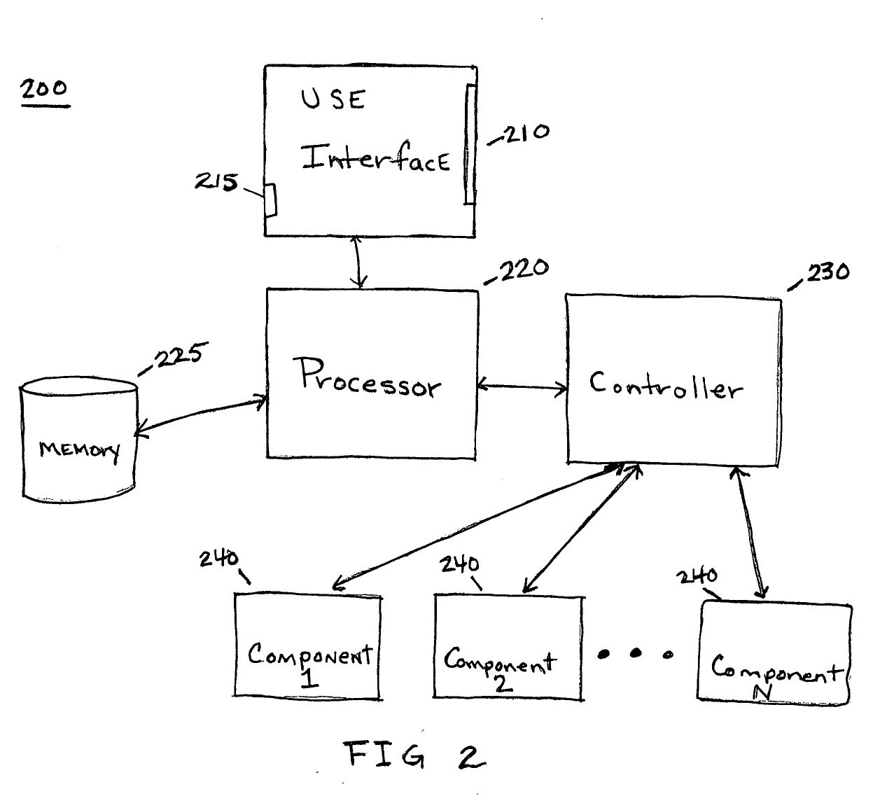

FIG. 2 illustrates a schematic diagram of an exemplary embodiment of the disclosed device 200. An exemplary embodiment of the device 200 comprises a user interface 210, a processor 220, a memory 225, component controller 230, and components 240.

The user interface 210 has a numeric keypad for entry of a numeric code by a user and a display for indicating the status of the device. The display can be light emitting diodes (LED), such as green, yellow and red that indicate the user is fully paid-up on his payments, behind on his payments, or that the device has disabled use of the vehicle. The display can also be an liquid crystal display or any device that provides a visual indication to a user. Of course, audio indications, e.g., beeps, can also be provided to the user.

Many U.S. States have laws that require an extended ‘first grace’ period. This can be accommodated in two ways: 1) by setting a grace period to a value equal or greater than the right to cure period—an LED can flash Orange for the entire period, or 2) by issuing a $0 payment code corresponding to the cure period—the LED can flash green until the cure period is over, then begin flashing Orange or Red, depending on the normally programmed grace period behavior. In the first accommodation, the end user can enter a ‘change mode’ command at least once, the second accommodation does not. Both modes can be available using the device software.

The user interface 210 can also include a connection point 215, e.g., Universal Serial Bus (USB) port, a wireless port or the like, for connection of a computer to the device. Connection point 215 can be used at the factory to install the necessary operating software and configure the device. Alternatively, the connection point 215 can be used to update the software and the payment schedule of the users (e.g., purchasers, renters lessees) at the site of installation or re-programming.

The memory 225 stores reference codes associated with payments for use of the equipment and information related to payment due dates, wherein the reference codes are assigned to an unlimited number of future calendar dates. The memory can be non-volatile memory, a hard drive or the like.

Although, payment due dates are referred to in the description one of ordinary skill would understand that dates can be hours, days (e.g., a day of the week, such as Tuesday or a calendar day, such as the 10th day of the month or Aug. 9, 1998), weeks, months, years, or any other specific time interval.

The processor 220 maintains a clock, which keeps track of time, i.e., hours, minutes, seconds, according to Greenwich Mean Time (GMT) with the appropriate offsets due to the geographical location of the device in different time zones. The processor 220 performs predetermined operations in response to a comparison of the numeric code entered via the user interface and the stored reference codes.

As explained above, the numeric code input by the user can be a special code that corresponds to a predetermined operation, such as entering an administrative mode that allows the device to be configured to perform certain functions as explained above.

The component controller 230 transmits a signal to a component device 240 based on the result of the comparison in the processor 220. If the inputted numeric code matches a reference code that is assigned to the user's payment due date, the processor 220 can transmit an enable signal to the component controller 230. The component controller 230 can send another signal to one of or all of the components 240 that are under its control to enable the continued use of the equipment.

Alternatively, if the inputted numeric code does not match reference code, the component controller 230 sends a signal to a component device 240 that disables a system necessary for operating the equipment.

The payment assurance device can then either output or not output a signal which would either disable or enable continued operation of the vehicle. The disablement device can control another device, such as a relay switch or similar device, via the output or failure to output to the other device. The other device can control a critical component of the equipment. For example, a critical component in a vehicle may be the starter, fuel pump, spark plug or other similar component, and in an appliance, the critical component may be the power supply, the power source, or a computer that controls the device.

One of ordinary skill in the art would understand that the exemplary embodiments can be implemented using software, written languages such as C++, firmware, hardware, or a combination of each.

One will now fully appreciate how exemplary embodiments of disclosed device is arranged and operates to encourage timely loan payments by disabling an automobile ignition. Further, that the device may be reset remotely and does not require being physically present at a loan center to be properly reset. Although the present invention has been described in considerable detail with clear and concise language and with reference to certain preferred versions thereof including the best mode anticipated by the inventor, other versions are possible. Therefore, the spirit and scope of the invention should not be limited by the description of the preferred versions contained therein, but rather by the claims appended hereto.

What is claimed is:

1. An apparatus installed on equipment for disabling the equipment when a payment for use of the equipment is not made by a user of the equipment, comprising:
a user interface for entering a numeric code by a user and display of status information;
a memory for storing reference codes associated with payments for use of the equipment and information related to payment due dates, wherein the reference codes are assigned to an unlimited number of future calendar dates;
a processor for maintaining a clock and performing predetermined operations in response to a comparison of a numeric code entered via the user interface and the stored reference codes; and
a component controller for transmitting a signal to a component device based on the result of the comparison, the component device either enabling or disabling operation of a system required to operate the equipment based on the transmitted signal.

2. The apparatus of claim 1, wherein the reference codes are selected from a subset of codes listed in one of a plurality of pre-existing code sequence tables, wherein the subset is less than all of the codes in the one code sequence table.

3. The apparatus of claim 2, wherein plural numeric codes cause the apparatus to perform additional functions based on entry of a specific special code, wherein one of the plural numeric codes is common to more than one apparatus.

4. The apparatus of claim 3, wherein one of the plural numeric codes places the equipment in operable condition for a predetermined amount of time after which predetermined amount of time the equipment is disabled.

5. A method for assuring the payment according to a repayment schedule of an obligation for using equipment by a device on the equipment, comprising:
selecting a subset of a plurality reference codes;
maintaining the current time and date;
assigning each of the reference codes in the subset to a specific time interval, wherein the specific time interval is a portion of a time period corresponding to repayment schedule of the obligation for using the equipment;
storing the subset of the plurality of codes, the specific individual time interval to which each code is assigned, and the time period;
receiving a user code via a user interface;
comparing the received user code to the subset of reference codes, the current time, current date, and time period corresponding to the repayment schedule of the obligation; and
disabling the equipment based on the results of the comparison.

6. The method of claim 5, wherein the selecting is performed by selecting the plurality of reference codes from a pre-existing set of reference code tables.

8. The method of claim 7, wherein the set of reference code tables have a greater number of codes than the selected subset of reference codes.

9. The method of claim 5, wherein the selected subset of reference codes exclude special codes and codes having repetitive sequences of characters.

10. The method of claim 9, wherein the selecting step includes selecting a first special code for placing the device in an administrative mode, wherein the first special code is shared by a plurality of devices having a device identifier similar to the device identifier of the device on the equipment.

11. The method of claim 9, wherein the first special code is mutable so as to be only shared by a sub-group of the plurality of devices based on the device identifier.

12. The method of claim 9, wherein a second special code is selected, wherein the second special code exits the administrative mode.

13. The method of claim 5, wherein the equipment is disabled if the device is in the administrative mode for longer than a predetermined time period.

12. The method of claim 4, comprising:
entering a change code via the user interface that places the device in a change mode.

14. The method of claim 13, comprising:
entering change instruction codes corresponding to the specification of new assignments and to new settings for the device, wherein the change instruction code contains error detection encoding.

15. The method of claim 5, wherein the storing comprises:
storing information including a base date of the repayment schedule, the date and time that the storing is performed, and a device identifier.

16. The method of claim 15, comprising:
testing the functionality of the device to confirm proper operation.

17. The method of claim 15, comprising:
uploading the stored information to an Internet service.

18. The method of claim 17, wherein the Internet service is securely accessed by a user for releasing a specific user code assigned to a specific time interval stored in a specific device.

19. The method of claim 18, wherein a user can obtain special codes to implement changes to the device, wherein one specific special code can change the code assignments and another special code can restore the original assignments.

20. The method of claim 5, wherein the storing is to a memory in a specific device having a specific device identification number.
